(19) United States
(12) Patent Application Publication
(10) Pub. No.: US 2006/0168268 A1
(43) Pub. Date: Jul. 27, 2006

(54) Specific method of setting transport-specific properties from transport-agnostic clients

(75) Inventors: Jeffrey Lee Barrett, Georgetown, TX (US); Richard Alan Sitze, Round Rock, TX (US); Gregory Louis Truty, Austin, TX (US); Ping Wang, Austin, TX (US)

Correspondence Address: IBM CORPORATION (SWP);C/O SUITER WEST SWANTZ PC LLO, 14301 FNB PARKWAY, SUITE 220, OMAHA, NE, 68154-5299, US

(73) Assignee: INTERNATIONAL BUSINESS MACHINES CORPORATION, ARMONK, NY (US)

(21) Appl. No.: 11/002,693

(22) Filed: Dec. 2, 2004

(51) Int. Cl. G06F 15/16

(52) U.S. Cl. 709/230

(57) ABSTRACT

The present invention is directed to a method and system of allowing the user-defined code to be written in such a way as to be independent on the underlying transport yet still send and receive information via transport-specific artifacts. As such, a user may not be required to develop unique code for each different transport. A developer may set user-defined transport-agnostic properties and associated values without concerning an underlying transport. A deployer will provide an external mapping of those user-defined transport-agnostic properties to one or more specific transports which are to be supported. The system may allow new or different transports to be supported by the user-defined code without requiring the developer to change the user-defined code. Only the mapping information decoupled from the user-defined properties may need to be changed for different transports.

### FIELD OF THE INVENTION

The present invention generally relates to the field of Web Service systems, and particularly to a method for providing programming interface and mapping information of user-defined transport-agnostic data suitable for being exchanged through different transports in a transport-specific manner.

### BACKGROUND OF THE INVENTION

Web Services are self-contained, self-describing, modular applications that can be published, located and invoked across the World Wide Web. Web Services are usually described by WSDL documents that separate out a serialization-agnostic form of the message (described by the PortType) and a serialization-specific form of the message (described by the binding). Clients of these services can aggregate the Web services to form an end-user application, enable business transactions, or create new Web services. Conventionally, a client sends a request to a Web Service at a given URL using the specific protocol over a specific transport (e.g. HTTP, or the like). The Web Service receives the request, processes it, and returns a response. Generally Web services are designed to be serialization-agnostic as well as transport-agnostic so that they can be accessed over any type of transport or application protocol. Most usages of web services do not care about the serialization format of the request. They are just interested in getting their data from point A to point B. However, there are cases where users desire to encode/decode information that can't be contained (or shouldn't be contained), within a message described by the web service WSDL itself. Thus, when end users desire to send and receive information (requests and responses) on transport-specific headers they would like to do so in a transport-agnostic way. However, the specifics of how the information is defined and where the information is transmitted vary between different transports. As a result, the user-defined data (information or the like) must be encoded in a transport-specific way for a given communication and therefore must be modified for each additional transport supported.

Therefore, it would be desirable to provide a method for additional transports to be supported without requiring any changes to the user-defined code in order to send or receive information via transport-specific headers. It would be also desirable to provide a method of allowing the user-defined code to be written in such a way as to be independent on the underlying transport and thus removing the requirement of unique code for each transport.

### SUMMARY OF THE INVENTION

Accordingly, the present invention provides a method and system of allowing the user-defined code to be written in such a way as to be independent on the underlying transport while still allowing the user-defined code to send and receive information in transport-specific headers without requiring a user to develop unique code for each different transport supported.

In a first embodiment of the present invention, a method of setting transport-agnostic properties suitable for being exchanged through a transport-specific way is provided. The method may provide a programming interface to allow a client to set user-defined transport-agnostic properties to be exchanged via transport-specific methods such as particular HTTP headers or JMS properties. A mapping mechanism in conjunction with the programming interface may be provided. The mapping mechanism may be utilized to map the user-defined transport-agnostic properties to specific transport artifacts. In this manner, the client may not have unique code for each different transport supported.

In a second embodiment of the present invention, a system of setting transport-specific properties from transport-agnostic clients is provided. A developer may set user-defined transport-agnostic properties and associated values without concerning an underlying transport. A deployer will provide an external mapping of those user-defined transport-agnostic properties to one or more specific transports which are to be supported. The system may allow new or different transports to be supported by the user-defined code without requiring the developer to change the user-defined code. Only the mapping information provided by the deployer needs to be changed.

In a further embodiment of the present invention, support logic is also provided for the user-defined code to retrieve user-defined transport-agnostic properties and associated values from an incoming transport flow. Even though the user-defined properties are actually received in a transport-specific manner, the user-defined code is transport-agnostic and is not tied to the details of mapping the properties based on the underlying transport. Thus, the user-defined code may be utilized to send and receive transport-specific information and still function across new and different transports without requiring code changes.

It is to be understood that both the foregoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is an illustration of a block diagram of exemplary Web Service system in accordance with an exemplary embodiment of the present invention;

FIG. 2 is an illustration of a flow diagram of a method implemented in accordance with an exemplary embodiment of the present invention; and

FIG. 3 is an illustration of a flow diagram of a method implemented in a runtime shown in FIG. 1 in accordance with an exemplary embodiment of the present invention.

### DETAILED DESCRIPTION OF THE INVENTION

Reference will now be made in detail to the presently preferred embodiments of the invention, examples of which are illustrated in the accompanying drawings.

The present invention is directed to a method and system of allowing the user-defined code to be written in such a way as to be independent on the underlying transport while still sending and receiving information in transport-specific artifacts without requiring unique code for each different transport supported.

The present invention may allow user-defined transport-agnostic properties to be exchanged via transport-specific methods (HTTP headers, JMS properties, or the like). A developer may set user-defined transport-agnostic properties and associated values without concerning an underlying transport. A deployer will provide an external mapping of those user-defined transport-agnostic properties to one or more specific transports which are to be supported. The system may allow new or different transports to be supported by the user-defined code without requiring the developer to change the user-defined code. Only the mapping information decoupled from the user-defined properties may need to be changed for different transports. Additionally, support logic may also be provided for the user-defined code to retrieve user-defined transport-agnostic properties and associated values from the incoming transport flows. Even though the user-defined properties are actually received in a transport-specific manner, the user-defined code may remain transport-agnostic and may not be tied to the details of mapping the properties for the underlying transport.

Advantageously, the user-defined properties may be decoupled from its mapping information so that the developer does not have to be concerned about the underlying transport of outgoing or incoming flow when the developer writes user-defined properties. Thus, the transport-agnostic user-defined code may be utilized to send and receive transport-specific information and still function across new and different transports without requiring code changes. In the following description, numerous specific descriptions are set forth in order to provide a thorough understanding of the present invention. It should be appreciated by those skilled in the art that the present invention may be practiced without some or all of these specific details. In some instances, well known process operations have not been described in detail in order not to obscure the present invention.

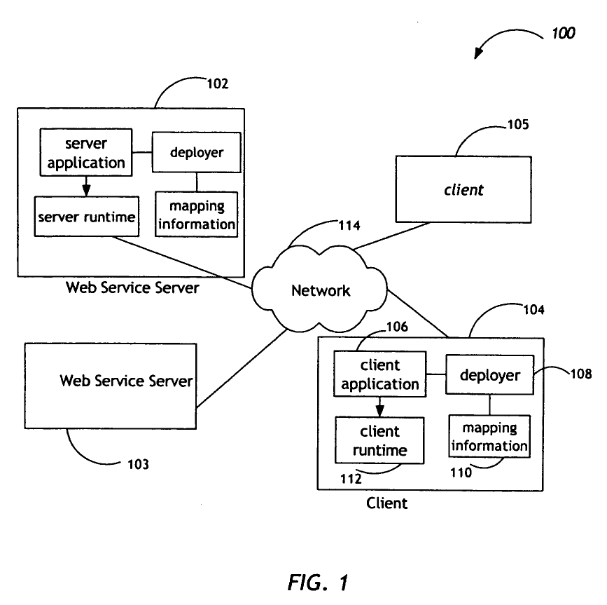

Referring generally now to FIGS. 1 through 3, exemplary embodiments of the present invention are shown.

Referring now to FIG. 1, a block diagram of exemplary Web Service system in accordance with the present invention is shown. Web Service Servers 102-103 are communicatively coupled with various clients 104, 105 through a network 114. Typically, the application on the client side handles the user interface and provides program logic for processing user input. Additionally, a client application must match the requirements of a particular server to provide communications with the particular server. Communication with the server is provided using processes that use protocols, such as hypertext transfer protocol (HTTP), secure sockets (SSL), Remote Method Invocation (RMI), or the like. In an embodiment of the present invention, a client 104, 105 may comprise a client application 106, deployer 108, client runtime 112, mapping information 110 or the like. A developer (a programmer) may write a user-defined code including a plurality of user-defined properties with associated values in transport-agnostic way. A deployer 108 may provide mapping information 110 for mapping the user-defined code for an underlying transport. A client runtime 112 may examine the user-defined code before it puts the code in outgoing flow. The client runtime 112 maps the user-defined code in accordance with the mapping information of the user-defined code. Then, the runtime engine sends the mapped user-defined code in a manner specific to a protocol to a designated endpoint (e.g. Web Service Server 102). The user-defined code may set user-defined transport-agnostic properties and values which will be sent in outgoing transport flows in a transport-specific manner. From the client 104, 105, the outgoing flows may be requests to the Server 102, 103 (from the server, the outgoing flows may be responses to the client 104, 105). The present invention may allow the user-defined properties to be exchanged in a transport-specific manner, but the user-defined code may remain transport-agnostic. The details of mapping these properties to the underlying transport (the mapping information 110) may be external to the user-defined properties.

In a particular embodiment of the present invention, clients and Web Service servers may be implemented in a J2EE (Java 2 Platform Enterprise Edition) platform. In an advantageous aspect of the present invention, the developer may not have to be concerned with the underlying transport. Instead, the developer may be concerned only with sending and receiving user-defined transport-agnostic properties and associated values. The deployer may provide an external mapping of those user-defined transport-agnostic properties to one or more specific transports which are to be supported. The present invention may allow new or different transports to be supported by the user-defined code without requiring the developer to make changes to the code. Advantageously, only the mapping information provided by the deployer may be required to be changed. Thus, the developer may not have to write unique code for each of the different transportations.

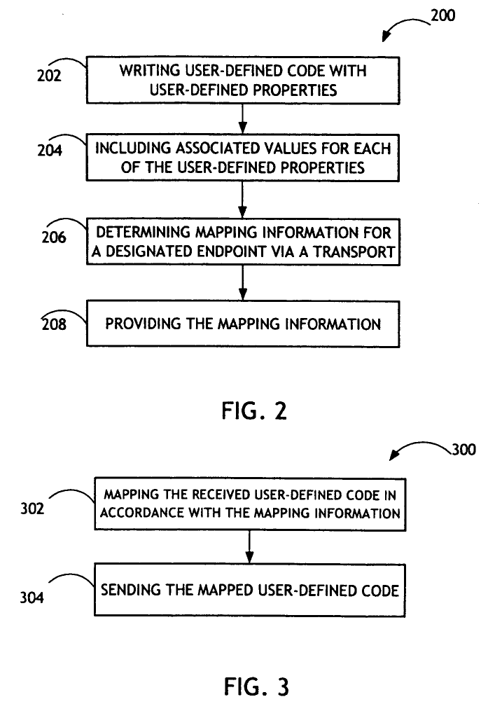

Referring now to FIG. 2, a flow diagram of a method implemented in accordance with the present invention is shown. In an embodiment of the present invention, a client may comprise a client application, a deployer, a client runtime, mapping information or the like. A developer (a programmer) may set user-defined properties with associated values in transport-agnostic way. The developer may not have to be concerned about the underlying transport. In Step 202, the developer may write a user-defined code with user-defined properties. In Step 204, associated values are included for each of the user-defined properties. The user-defined code (the user-defined properties with the values and the like) may be provided for the deployer. Then, the deployer may determine proper mapping information of the user-defined properties for a designated endpoint via a particular transport in Step 206. The designated endpoint may be one of Web Service Servers, Web Service applications, or the like. The deployer may provide the mapping information to the user-defined code in Step 208.

In a particular embodiment of the present invention, a collection of user-defined properties may be given to the runtime prior to invoking the runtime. For outgoing flows, the value for each user-defined property may be included in the collection; those values will be sent on the outgoing flows. For incoming flows the values may be retrieved from the incoming flow and returned to the user-defined code. The deployer may provide mapping information between user-defined properties and transport-specific entities such as a HTTP header or a JMS property in which the user-defined property is to flow. For outgoing flows, the runtime may examine the collection of user-defined properties and use the mapping information provided by the deployer to send the user-defined protocol-agnostic properties in a manner specific to a given protocol.

Referring now to FIG. 3, a flow diagram of a method implemented in an embodiment of the present invention when the runtime receives a collection of the user-defined properties for outgoing flow is shown. In a particular embodiment, a collection of user-defined properties may be given to the runtime prior to invoking the runtime. In Step 302, the runtime may map the received collection of user-defined properties in accordance with the mapping information. Then, the runtime may send the mapped user-defined properties in the outgoing flow in Step 304.

In another particular embodiment of the present invention, a JAX-RPC Java Specification Request (JSR)-101 Web Service client programming model and XML mapping information may be utilized. Generally, JAX-RPC stands for Java API for XML-based RPC. JAX-RPC defines how Java classes can be described in a WSDL document and how an existing WSDL document can be implemented in Java. It also defines a client API to invoke a remote Web service and a runtime environment on the server to host a Web service. However, it is to be noted that the client programming model and the XML mapping information are for illustrative purpose only. One of ordinary skills in the art will appreciate that various client/server programming models may be utilized in the present invention. Further, it is to be noted that there are various ways to provide mapping information of user-defined properties to transport-specific entities.

### EXAMPLES

In a particular embodiment of the present invention, a transport-agnostic code fragment based on the JAX-RPC JSR-101 Web services client programming model may be defined as follow:

// Create a collection of user-defined properties to be sent
// on outgoing flows (i.e. requests from the client perspective).
HashMap sendProps = new HashMap( );
sendProps.put (“ClientAuthenticationToken”,
“My_client_authentication_token”);
sendProps.put(“StoreID”, “My_store_ID”);
// The “Stub” is a JSR-101 JAX-RPC Client programming model
// artifact. Setting the property below gives the runtime access to
// the collection containing the user-defined properties.
myStub._setProperty
(Constants.SEND_TRANSPORT_PROPERTIES, sendProps);
// Create a collection of user-defined properties to be retrieved
// from incoming flows (i.e. responses from the client perspective) .
// Note that the collection only needs a key; the value is ignored
// and will be retrieved from the incoming flow.
HashMap rcvdProps = new HashMap( );
rcvdProps.put (“ServerAuthenticationToken”, null);
// See comment on “Stub” above.
myStub._setProperty
(Constants.RECEIVE_TRANSPORT_PROPERTIES, rcvdProps);
// Invoke the runtime.
myStub.myMethod( );
// Get the values we are interested in from the incoming flow.
// Given the HTTP flow example below, the returned value would
// be “My_server_token”
String serverAuthValue= (String)
rcvdProps.get (“ServerAuthenticationToken”);

In the above exemplary code fragment, the user-defined property ClientAuthenticationToken may be sent over HTTP in the HTTP Header Cookie and over JMS in the JMS property AuthenticationInformation. In either case the code written by thq developer is identical and is unaware of the underlying transport.

An example of the mapping information (XML mapping information) from user-defined properties in the transport-agnostic code fragment to transport-specific headers (HTTP Headers) or properties (JMS properties) is as follow:

```
<transportProperties type=“http”>
    <transportSeperator>:</>
    <deliminator>;</>
    <nameValueSeperator>=</>
    <property name=“ClientAuthenticationToken” mapping=“Cookie”
flow=“both” access-“rw” location=“prepend”>
    <property name=“ StoreID” mapping=“Cookie2” flow=“sent”>
    <property name=“ ServerAuthenticationToken”
      mapping=“MyAuthenticationHeader”>
</transportProperties >
<transportProperties type=“jms”>
    <dehminator>;</>
    <nameValueSeperator>&</>
    <property name=“ClientAuthenticationToken”
  mapping=“Authenticationlnformation”
      flow=“both” access=“rw” location=“prepend”>
    <property name=“ StoreID” mapping=“Jms2” flow=“sent”>
    <property name=“ ServerAuthenticationToken” mapping=“Jms1”>
</transportProperties>
```

The above exemplary XML fragment describes the mapping information between the transport-agnostic user-defined properties and the transport-specific mapping. For example, the XML fragment identifies the transport in terms of a URL protocol prefix (type=“http”). Further, the syntax for sending transport-specific information is described. For example, the syntax may include 1) the separator between a transport entity and its value (transportSeperator), 2) the separator between multiple values in a transport entity (deliminator), 3) the separator between a property and its associated value (nameValueSeperator). The XML fragment also describes the mapping of a user-defined property which includes 1) the user-defined property (name), 2) the transport entity to map to (mapping) 3) if the property is to be sent, received, or both (flow); if the property is readable, writeable, or both (access) 4) where the property is placed in the transport entity (location). It should be appreciated that there are numerous ways of providing the mapping information such as via properties or a plug-in/callout mechanism. After the mapping in the runtime, an outgoing/incoming flow HTTP fragment is generated.

The example of an outgoing flow HTTP fragment may be defined as follow:
Cookie: ClientAuthenticationToken=My_client_authentication_token; JSESSID=12345678
Cookie2: StoreID=My_store_ID

The example of an incoming Flow HTTP fragment may be defined as follow:
Set-Cookie: JSESSID=12345678
MyAuthenticationHeader: ServerAuthenticationToken=My_server_token

In the exemplary embodiments, the methods disclosed may be implemented as sets of instructions or software readable by a device. Further, it is understood that the specific order or hierarchy of steps in the methods disclosed are examples of exemplary approaches. Based upon design preferences, it is understood that the specific order or hierarchy of steps in the method can be rearranged while remaining within the scope and spirit of the present invention. The accompanying method claims present elements of the various steps in a sample order, and are not necessarily meant to be limited to the specific order or hierarchy presented.

It is believed that the method and system of the present invention and many of its attendant advantages will be understood by the forgoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A method of setting transport-specific properties from transport-agnostic clients and servers, comprising:
writing user defined code including user-defined properties and associated values,
wherein the user-defined code is transport-agnostic;
determining and generating mapping information for a specific transport;
providing the mapping information,
wherein the user-defined code is suitable for being sent to an endpoint through a transport specific protocol.

2. The method as described in claim 1, wherein the user-defined code with the mapping information is provided to a runtime engine.

3. The method as described in claim 2, further comprising:
mapping the user-defined code in accordance with the mapping information;
sending the mapped user-defined code in a manner specific to a protocol.

4. The method as described in claim 2, wherein the user-defined code with the mapping information is provided before the runtime engine is invoked.

5. The method as described in claim 1, wherein the deployer provide the mapping information between the user defined properties and a plurality of transport specific entities.

6. The method as described in claim 5, wherein one of the plurality of transport specific entities is a HTTP header.

7. The method as described in claim 5, wherein one of the plurality of transport specific entities is a JMS property.

8. The method as described in claim 1, wherein the runtime utilizes a default mapping information when the mapping information is not provided.

9. A method of providing a programming interface in conjunction with a mapping mechanism, the programming interface being independent of an underlying transport, comprising:
setting a plurality of user-defined properties,
wherein the plurality of user-defined properties are transport-agnostic properties;
including an associated value in each of the plurality of user-defined properties, wherein a collection of the plurality of user-defined properties being sent on an outgoing flow;
including retrieval information of the plurality of user-defined properties and associated values, the retrieval information being used in an incoming flow; and
providing the collection of the plurality of user-defined properties to a deployer, the deployer providing the mapping mechanism to the collection of the plurality of user-defined properties,
wherein the deployer is capable of determining the mapping mechanism for the endpoint via an underlying transport.

10. The method as described in claim 9, further comprising:
mapping the user-defined properties in accordance with the mapping mechanism;
sending the mapped user-defined properties in a manner specific to a protocol,
wherein the user-defined properties with the mapping mechanism is provided to a runtime.

11. The method as described in claim 9, wherein the outgoing flow is a request from a client and a response from the Web server.

12. The method as described in claim 9, wherein a value for each of the plurality of the user-defined property is retrieved from the incoming flow and returned to the user-defined code.

13. A system of setting transport-specific properties from transport-agnostic clients and servers, comprising:
a user-defined code including a plurality of user-defined properties with associated values, the plurality of user-defined properties being transport-agnostic;
a mapping information suitable for mapping the user-defined code for an underlying transport
a deployer for providing the mapping information for the user-defined code;
a runtime engine communicatively coupled to the deployer, the runtime engine for mapping the user-defined code in accordance with the mapping information provided by the deployer,
wherein the runtime engine sends the mapped user-defined code in a manner specific to a protocol to a designated endpoint.

14. The system as described in claim 13, wherein the deployer generates the mapping information.

15. The system as described in claim 13, wherein the runtime utilizes a default mapping information when the mapping information is not provided by the deployer.

16. The system as described in claim 13, wherein the mapping information is a declarative form.

17. The system as described in claim 13, wherein the mapping information is a XML configuration file.

18. The system as described in claim 13, wherein the programming interface is JAX-RPC.

19. A system for allowing transport-agnostic clients and servers to set transport-specific properties, comprising:
means for writing user-defined code including user-defined properties and associated values, the user define code being sent to an endpoint,
wherein the user-defined code is transport-agnostic;
means for determining an underlying transport;
means for generating mapping information based on the transport information;
means for providing the mapping information of the user-defined code.

20. The system as described in claim 19, further comprising:
means for mapping the user defined code in accordance with the mapping information;
means for sending the mapped user-defined code in a manner specific to a protocol,
wherein the user-defined code and the mapping information are provided.
